(19) United States
(12) Patent Application Publication
(10) Pub. No.: US 2025/0085432 A1
(43) Pub. Date: Mar. 13, 2025

(54) SENSING SYSTEM, AGRICULTURAL MACHINE, AND SENSING DEVICE

(71) Applicant: Kubota Corporation, Osaka (JP)

(72) Inventor: Akira CHABATA, Sakai-shi (JP)

(21) Appl. No.: 18/958,687

(22) Filed: Nov. 25, 2024

Related U.S. Application Data
(63) Continuation of application No. PCT/JP2023/019920, filed on May 29, 2023.

(30) Foreign Application Priority Data
May 31, 2022 (JP) 2022-088213

(51) Int. Cl. G01S 17/931; A01B 69/00; G01S 7/481; G01S 17/89; G01S 19/43; G06T 7/73

(52) U.S. Cl. CPC G01S 17/931; A01B 69/001; G01S 7/4811; G01S 17/89; G01S 19/43; G06T 7/74; G06T 2207/30188; G06T 2207/30204; G06T 2207/30244; G06T 2207/30261

(57) ABSTRACT

A sensing system includes a first range sensor mounted on a work vehicle, a second range sensor mounted on an implement connected to the work vehicle, a marker located in a sensing range of the first range sensor, and a processor configured or programmed to estimate a pose of the second range sensor relative to the first range sensor based on first sensor data generated by the first range sensor sensing a region including the marker, and output data indicating the estimated pose.

### CROSS REFERENCE TO RELATED APPLICATIONS

This application claims the benefit of priority to Japanese Patent Application No. 2022-088213 filed on May 31, 2022 and is a Continuation Application of PCT Application No. PCT/JP2023/019920 filed on May 29, 2023. The entire contents of each application are hereby incorporated herein by reference.

### BACKGROUND OF THE INVENTION

### 1. Field of the Invention

The present disclosure relates to sensing systems, agricultural machines, and sensing devices.

### 2. Description of the Related Art

Research and development of smart agriculture that employs information and communication technology (ICT) and the Internet of things (IoT), as the next-generation agriculture, are under way. Automated and unmanned operations of agricultural machines such as tractors, rice transplanters, and combine harvesters used in fields have been being studied and developed. For example, work vehicles that perform agricultural work while automatically traveling within fields using a positioning system such as a global navigation satellite system (GNSS) that can perform precise positioning have been put into practice.

Meanwhile, work vehicles that automatically travel using a range sensor such as light detection and ranging (LiDAR) have also been being developed. For example, Japanese Laid-Open Patent Publication No. 2019-154379 describes an example of a work vehicle that recognizes crop rows in a field using a LiDAR sensor, and automatically travels between crop rows. Japanese Laid-Open Patent Publication No. 2019-170271 describes an example of a work vehicle that automatically travels along a target path set in a field while detecting obstacles using a LiDAR sensor.

### SUMMARY OF THE INVENTION

In work vehicles that automatically travel while sensing a surrounding environment using a range sensor such as a LiDAR sensor, the sensing may be hampered by an implement connected to the work vehicle. For example, when an implement is connected to the front portion of a work vehicle, blind spots occur in the sensing range in front of the work vehicle, so that the sensing is hampered.

Example embodiments of the present invention provide techniques for reducing the hampering of sensing due to an implement.

A sensing system according to an example embodiment of the present disclosure includes a first range sensor mounted on a work vehicle, a second range sensor mounted on an implement connected to the work vehicle, a marker located in a sensing range of the first range sensor, and a processor configured or programmed to estimate a pose of the second range sensor relative to the first range sensor based on first sensor data generated by the first range sensor sensing a region including the marker, and output data indicating the estimated pose.

Example embodiments of the present disclosure may be implemented using devices, systems, methods, integrated circuits, computer programs, non-transitory computer-readable storage media, or any combination thereof. The computer-readable storage media may be inclusive of volatile storage media or non-volatile storage media. The devices may each include a plurality of devices. In the case where the devices each include two or more devices, the two or more devices may be included within a single apparatus, or divided over two or more separate apparatuses.

According to the example embodiments of the present disclosure, it is possible to avoid the hampering of sensing by an implement.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view schematically illustrating an agricultural machine according to an illustrative example embodiment of the present disclosure.

FIG. 2 is a diagram illustrating an example configuration of a marker.

FIG. 3 is a diagram for describing a process of estimating a pose of a second LiDAR sensor relative to a first LiDAR sensor.

FIG. 4 is a diagram illustrating another example marker.

FIG. 5 is a diagram illustrating another example sensing system.

FIG. 6 is a diagram illustrating an example of a marker having a plurality of portions having different colors.

FIG. 7 is a diagram illustrating still another example sensing system.

FIG. 8 is a diagram for outlining a system according to an illustrative example embodiment of the present disclosure.

FIG. 9 is a side view schematically illustrating an example of a work vehicle, and an implement connected to the work vehicle.

FIG. 10 is a block diagram illustrating an example configuration of a work vehicle and an implement.

FIG. 11 is a conceptual diagram illustrating an example of a work vehicle performing positioning based on RTK-GNSS.

FIG. 12 is a diagram schematically illustrating an example of an environment in which a work vehicle travels.

FIG. 13A is a diagram schematically illustrating an example travel path of a work vehicle.

FIG. 13B is a diagram schematically illustrating another example travel path of a work vehicle.

FIG. 14 is a flowchart illustrating an example operation of steering control during self-driving performed by a controller.

FIG. 15A is a diagram illustrating an example of a work vehicle that travels along a target path.

FIG. 15B is a diagram illustrating an example of a work vehicle that is located at a position away from and to the right of a target path.

FIG. 15C is a diagram illustrating an example of a work vehicle that is located at a position away from and to the left of a target path.

FIG. 15D is a diagram illustrating an example of a work vehicle that faces in a direction tilted with respect to a target path.

FIG. 16 is a flowchart illustrating a specific example of a localization process.

### DETAILED DESCRIPTION OF THE EXAMPLE EMBODIMENTS

As used herein, the term “work vehicle” refers to a vehicle used to perform work at work sites. The term “work site” refers to any place where work is performed, such as fields, forests, or construction sites. The term “field” refers to any place where agricultural work is performed, such as orchards, cultivated fields, rice fields, grain farms, or pastures. The work vehicle may be an agricultural machine such as a tractor, rice transplanter, combine harvester, vehicle for crop management, or riding mower, or a vehicle used for purposes other than agriculture such as a construction work vehicle or snowplow. In the present disclosure, an implement (also referred to as a “work machine” or “work apparatus”) suitable for the type of work can be attached to at least one of the front and back of a work vehicle. The traveling of a work vehicle while performing work is in some cases referred to as “work-traveling.”

The term “agricultural machine” refers to a machine for agricultural applications. Examples of agricultural machines include tractors, harvesters, rice transplanters, vehicles for crop management, vegetable transplanters, mowers, seeders, spreaders, and mobile robots for agriculture. Not only may a work vehicle such as a tractor function as an “agricultural machine” alone by itself, but also a combination of a work vehicle and an implement that is attached to, or towed by, the work vehicle may function as an “agricultural machine”. For the ground surface inside a field, the agricultural machine performs agricultural work such as tilling, seeding, preventive pest control, manure spreading, planting of crops, or harvesting.

The term “self-driving” means controlling the traveling of a vehicle under the control of a controller, without manual operations performed by the driver. During self-driving, not only the traveling of a vehicle but also work operations (e.g., operations of an implement) may be automatically controlled. The traveling of a vehicle by self-driving is referred to as “automatic traveling.” The controller may be configured or programmed to control at least one of steering required for the traveling of a vehicle, adjustment of traveling speed, and starting and stopping of traveling. When controlling a work vehicle to which an implement is attached, the controller may be configured or programmed to control operations such as raising and lowering of the implement, and starting and stopping of the operation of the implement. Traveling by self-driving may include not only the traveling of a vehicle along a predetermined path toward a destination, but also the traveling of a vehicle to follow a tracked target. A vehicle that performs self-driving may travel partially based on the user's instructions. A vehicle that performs self-driving may operate in a self-driving mode as well as a manual driving mode in which the vehicle travels according to manual operations performed by the driver. Steering of a vehicle that is not manually performed and is instead performed under the control of the controller is referred to as “automatic steering.” All or a portion of the controller may be provided external to the vehicle. Control signals, commands, data, and the like may be exchanged by communication between the vehicle and the controller external to the vehicle. A vehicle that performs self-driving may travel autonomously while sensing a surrounding environment without any human being involved with control of the traveling of the vehicle. A vehicle capable of traveling autonomously can perform unmanned traveling. Such a vehicle may detect and avoid obstacles during autonomous traveling.

The term “range sensor” refers to a sensor that is used to measure distances. The range sensor is configured to measure distances to one or more remote points, and output data indicating the distances, or data indicating the positions of the remote points that have been obtained by converting the distances. Examples of the range sensor include LiDAR sensors, time of flight (TOF) cameras, stereo cameras, or any combinations thereof. The LiDAR sensor emits light (e.g., infrared light or visible light) in order to measure distances. To measure distances, for example, a technique for measuring distances, such as time of flight (TOF) or frequency modulated continuous wave (FMCW), may be used.

The term “environmental map” refers to data representing, with a predetermined coordinate system, the positions or regions of objects existing in an environment in which a work vehicle travels. Examples of the coordinate system that is used to specify an environmental map include not only world coordinate systems such as a geographic coordinate system fixed to the earth, but also odometry coordinate systems that indicate poses based on odometry information. The environmental map may contain, in addition to positions, other information (e.g., attribute information and other information) about objects existing in an environment. Environmental maps include various types of maps, such as point group maps and grid maps.

Hereinafter, example embodiments of the present disclosure will be described. Note, however, that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of the claims. In the following description, elements having identical or similar functions are denoted by identical reference numerals.

The following example embodiments are only exemplary, and the techniques according to the present disclosure are not limited to the following example embodiments. For example, numerical values, shapes, materials, steps, orders of steps, layout of a display screen, etc., which are indicated in the following example embodiments are only exemplary, and admit of various modifications so long as it makes technological sense. Any one implementation may be combined with another so long as it makes technological sense to do so.

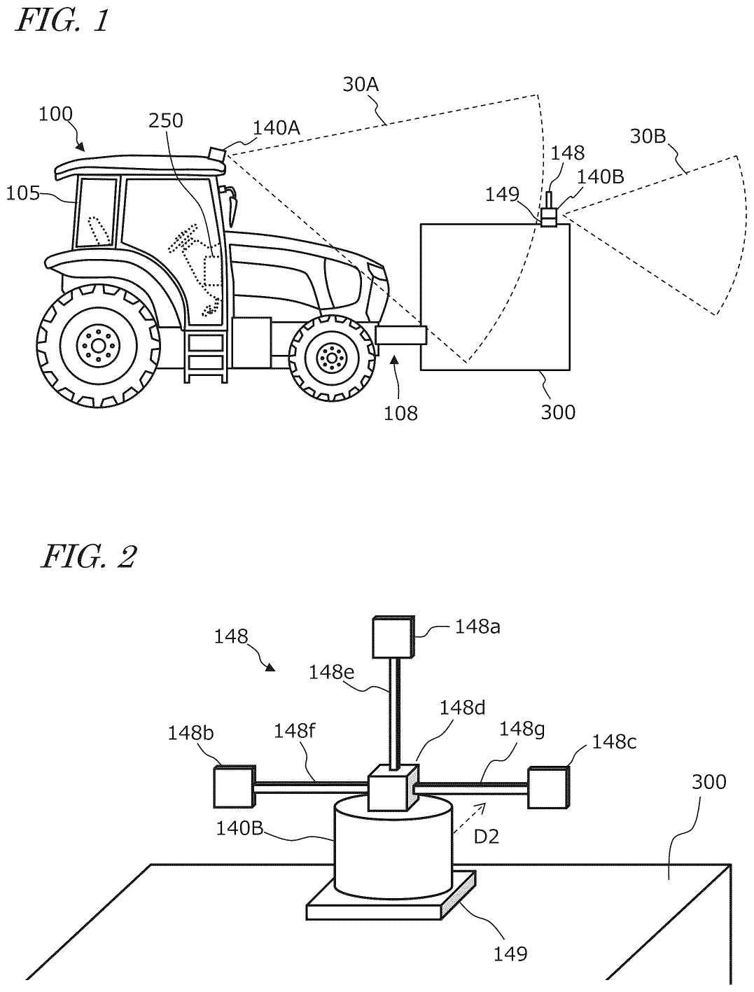

FIG. 1 is a side view schematically illustrating an agricultural machine according to an illustrative example embodiment of the present disclosure. The agricultural machine of FIG. 1 includes a work vehicle 100, and an implement 300 connected to the work vehicle 100. In this example embodiment, the work vehicle 100 is a tractor. The work vehicle 100 includes a linkage device 108 at a front portion thereof. The implement 300 is connected to the front portion of the work vehicle 100 through the linkage device 108. The work vehicle 100 may have a linkage device to connect an implement at a rear portion thereof. In FIG. 1, any rear linkage device or rear implement is not illustrated. The implement 300 may be any work machine that performs agricultural work in front of the work vehicle 100, such as a front loader, harvester, sweeper, or sprayer.

The agricultural machine of FIG. 1 includes a sensing system to sense an environment around the work vehicle 100. The sensing system may, for example, be used for obstacle detection or localization. The work vehicle 100 may be configured to automatically travel based on the result of localization performed using the sensing system.

The sensing system of this example embodiment includes a first LiDAR sensor 140A, a second LiDAR sensor 140B, a marker 148, and a processor 250. The first LiDAR sensor 140A is an example of a first range sensor. The second LiDAR sensor 140B is an example of a second range sensor. The first LiDAR sensor 140A is mounted on the work vehicle 100. In the example of FIG. 1, the first LiDAR sensor 140A is mounted in the vicinity of a front end of an upper portion of a cabin 105 of the work vehicle 100. The second LiDAR sensor 140B is mounted on the implement 300. In the example of FIG. 1, the second LiDAR sensor 140B is mounted in the vicinity of a front end of an upper portion of the implement 300. The first LiDAR sensor 140A and the second LiDAR sensor 140B are mounted at other positions.

The second LiDAR sensor 140B is external to the implement 300. The second LiDAR sensor 140B may, for example, be operated by power supplied from a battery or the implement 300. The second LiDAR sensor 140B of FIG. 1 includes a mounting structure 149 to mount the second LiDAR sensor 140B on the implement 300. The mounting structure 149 may, for example, include various structural elements mount the second LiDAR sensor 140B on the implement 300, such as a magnet, bolt and nut, screw, or connecting hardware. The mounting structure 149 allows the second LiDAR sensor 140B to be easily mounted on or removed from the implement 300. The second LiDAR sensor 140B may be mounted at a position on the implement 300 where there is no obstacle between itself and the first LiDAR sensor 140A, and there are relatively few blind spots in the front range.

The implement 300 may be provided with a fixing device to fix the second LiDAR sensor 140B. The fixing device may, for example, have a structure that engages with the mounting structure 149 of the second LiDAR sensor 140B. In that case, when the mounting structure 149 is engaged with the fixing device, the second LiDAR sensor 140B is fixed to the implement 300.

The second LiDAR sensor 140B may be mounted on not only the particular implement 300 but also various other implements. Therefore, sensing described below is allowed irrespective of the type of the implement 300. The second LiDAR sensor 140B, which is thus external to the implement 300, can be manufactured or sold separately.

The marker 148 is arranged in the sensing range of the first LiDAR sensor 140A. In the example of FIG. 1, the marker 148 is attached to the second LiDAR sensor 140B. The marker 148 may be provided on the implement 300 at a position away from the second LiDAR sensor 140B. A relationship in position and orientation between the marker 148 and the second LiDAR sensor 140B is known. Such information may be previously stored in a storage that is internal or external to the processor 250. The marker 148 may, for example, include one or more reflective portions that have a higher reflectance with respect to light emitted from the first LiDAR sensor 140A than that of the other portion of the marker 148.

As illustrated in FIG. 1, in the case in which the second LiDAR sensor 140B is provided on the implement 300 in front of the work vehicle 100, the first LiDAR sensor 140A is arranged so as to sense at least an area in front of the work vehicle 100. The first LiDAR sensor 140A senses a region including the marker 148 to generate and output first sensor data. Meanwhile, the second LiDAR sensor 140B senses an area in front of the implement 300 to generate and output second sensor data. FIG. 1 illustrates a sensing range 30A of the first LiDAR sensor 140A and a sensing range 30B of the second LiDAR sensor 140B, which are in the shape of a circular sector indicated by a dashed line. The sensing ranges 30A and 30B each have a spread not only in the vertical direction but also in the horizontal direction, which becomes broader in the traveling direction of the work vehicle 100.

The first LiDAR sensor 140A and the second LiDAR sensor 140B may each be a scanning sensor that scans a space using, for example, a laser beam to generate information indicating the distribution of objects in the space. A LiDAR sensor may, for example, be configured to measure a distance to a reflection point positioned on the surface of an object using the ToF method. The LiDAR sensor that measures distances using the ToF method emits laser pulses, i.e., a pulsed laser beam, and measures the time that it takes for the laser pulses reflected by an object existing in a surrounding environment to return to the LiDAR sensor. The method for measuring distances is not limited to the ToF method, and may be other methods such as the FMCW method. In the FMCW method, light whose frequency is linearly changed over time is emitted, and a distance is calculated based on the beat frequency of interference light generated by interference between the emitted light and reflected light. Based on the distance and direction of a reflection point, the coordinates of the reflection point in a coordinate system fixed to the work vehicle 100 are calculated. Scanning LiDAR sensors can be divided into two-dimensional LiDAR sensors and three-dimensional LiDAR sensors. A two-dimensional LiDAR sensor may scan an environment by rotating a laser beam in a single plane. Meanwhile, a three-dimensional LiDAR sensor may, for example, scan an environment by rotating a plurality of laser beams along different conical surfaces. The first LiDAR sensor 140A and the second LiDAR sensor 140B of FIG. 1 are each a three-dimensional LiDAR sensor, or alternatively, may be a two-dimensional LiDAR sensor.

The first LiDAR sensor 140A and the second LiDAR sensor 140B are not limited to a scanning sensor, or may each be a flash sensor that emits light diffusing in a wide range to obtain information about the distribution of distances to objects in a space. Scanning LiDAR sensors use light having an intensity higher than that of flash LiDAR sensors, and therefore, can obtain information about greater distances. Meanwhile, flash LiDAR sensors have a simple structure and can be manufactured at low cost, and therefore, are suitable for applications that do not require strong light.

In this example embodiment, in addition to the first LiDAR sensor 140A mounted on the work vehicle 100, the second LiDAR sensor 140B mounted on the implement 300 is provided. If the second LiDAR sensor 140B is not provided, sensing of an area in front of the implement 300 is obstructed because the implement 300 is positioned in the sensing range of the first LiDAR sensor 140A. In particular, in the case in which the implement 300 provided in front of the work vehicle 100 has a large size, many blind spots occur in the sensing range of the first LiDAR sensor 140A, and therefore, data sufficient for obstacle detection or localization cannot be obtained. To address such a problem, in this example embodiment the second LiDAR sensor 140B is externally mounted on the implement 300. Obstacle detection or localization is performed based on the second sensor data output from the second LiDAR sensor 140B. The first LiDAR sensor 140A may be used to estimate the pose of the second LiDAR sensor 140B. The first sensor data output from the first LiDAR sensor 140A and the second sensor data output from the second LiDAR sensor 140B may be combined to generate point cloud data indicating the distribution of objects on the ground around the work vehicle 100.

The processor 250 may be a computer that is configured or programmed to process data output from the first LiDAR sensor 140A and the second LiDAR sensor 140B. In the example of FIG. 1, the processor 250 is arranged in or on the cabin 105 of the work vehicle 100. The processor 250 may be implemented as a portion of the controller that is configured or programmed to control the operation of the work vehicle 100. The processor 250 may, for example, be implemented by an electronic control unit (ECU). The processor 250 may be arranged not only in or on the cabin 105 but also at other positions. For example, the processor 250 may be included in the first LiDAR sensor 140A. The processor 250 may be implemented by a plurality of computers or a plurality of circuits. A portion of the functions of the processor 250 may be implemented by an external computer such as a server located away from the work vehicle 100.

The processor 250 may be connected to the first LiDAR sensor 140A and the second LiDAR sensor 140B by wireless communication (e.g., Bluetooth (registered trademark) or 4G or 5G communication) or wired communication (e.g., CAN communication). The processor 250 is configured or programmed to obtain the first sensor data from the first LiDAR sensor 140A, and the second sensor data from the second LiDAR sensor 140B.

The processor 250 is configured or programmed to estimate, based on the first sensor data, the pose of the second LiDAR sensor 140B relative to the first LiDAR sensor 140A. For example, based on information about the relationship in position and orientation between the second LiDAR sensor 140B and the marker 148, and the first sensor data, the processor 250 is configured or programmed to estimate the pose of the second LiDAR sensor 140B relative to the first LiDAR sensor 140A. As used herein, the term “pose” refers to a combination of a position and an orientation. In the following description, the pose of the second LiDAR sensor 140B relative to the first LiDAR sensor 140A is in some cases simply referred to as “the pose of the second LiDAR sensor 140B.”

The positional relationship between the work vehicle 100 and the implement 300 is not invariable. The pose of the implement 300 relative to the work vehicle 100 may vary depending on the play of the linkage device 108 or the operation of the implement 300 itself. For example, when the work vehicle 100 is traveling, the implement 300 may wobble up and down or from side to side relative to the work vehicle 100. Due to this, the second LiDAR sensor 140B may also wobble up and down or from side to side relative to the work vehicle 100. In order to utilize the second sensor data output from the second LiDAR sensor 140B in the self-driving of the work vehicle 100, the second sensor data needs to be converted into data represented in a coordinate system that is fixed to the work vehicle 100. This coordinate conversion requires information about the pose of the second LiDAR sensor 140B relative to the first LiDAR sensor 140A (or the work vehicle 100). To this end, the processor 250 is configured or programmed to estimate the pose of the second LiDAR sensor 140B relative to the first LiDAR sensor 140A based on the first sensor data generated by the first LiDAR sensor 140A sensing a region including the marker 148.

The processor 250 can estimate the pose of the second LiDAR sensor 140B relative to the first LiDAR sensor 140A based on the position and/or shape of one or more reflective portions of the marker 148. A specific example of this process will be described below.

FIG. 2 is a diagram illustrating an example configuration of the marker 148. In this example, the marker 148 has three reflective portions 148a, 148b, and 148c. The reflective portions 148a, 148b, and 148c each have, for example, a reflective surface on which a reflective material such as reflective tape that reflects light emitted from the first LiDAR sensor 140A with a high reflectance is provided. The marker 148 may be arranged such that the reflective surface of each of the reflective portions 148a, 148b, and 148c faces toward the first LiDAR sensor 140A. For example, the marker 148 may be arranged such that the direction of a line normal to the reflective surface of each of the reflective portions 148a, 148b, and 148c is close to the direction of the first LiDAR sensor 140A. A retroreflective material (e.g., retroreflective tape) may be provided on the reflective surface of each of the reflective portions 148a, 148b, and 148c. If the retroreflective material is used, a light beam emitted from the light-emitting unit of the first LiDAR sensor 140A can be reflected toward a light-receiving unit of the first LiDAR sensor 140A. The reflective surface of each of the reflective portions 148a, 148b, and 148c has a two-dimensional spread, and may, for example, has a size of greater than 10 mm×10 mm. The reflective surface of each of the reflective portions 148a, 148b, and 148c may have a size of greater than 30 mm×30 mm. As the size of the reflective surface increases, it is easier to detect the reflective portions 148a, 148b, and 148c based on the first sensor data.

FIG. 2 illustrates three reflective portions 148a, 148b, and 148c, which are supported by three support posts 148e, 148f, and 148g, respectively, extending three directions from a base portion 148d at a middle of the marker 148. The three support posts 148e, 148f, and 148g are arranged in a plane perpendicular to a front direction D2 of the second LiDAR sensor 140B. The three support posts 148e, 148f, and 148g extend in the plane in different directions separated from each other by 90 degrees. The support posts 148f and 148g extend leftward and rightward, respectively, with respect to the front direction D2 of the second LiDAR sensor 140B. The support post 148e extends vertically upward. In the example of FIG. 2, the support posts 148e, 148f, and 148g have equal lengths. The three reflective portions 148a, 148b, and 148c are provided at the tips of the three support posts 148e, 148f, and 148g, respectively. Thus, the reflective portions 148a, 148b, and 148c are provided at positions separated from each other in the three directions, i.e., leftward, rightward, and vertical directions, with respect to the base portion 148d. Such an arrangement facilitates estimation of the pose of the second LiDAR sensor 140B. It should be noted that the positional relationship between the three reflective portions 148a, 148b, and 148c is not limited to the illustrated relationship and may be changed as appropriate.

The first LiDAR sensor 140A performs beam scanning in a region including the three reflective portions 148a, 148b, and 148c to generate the first sensor data indicating a distance distribution or position distribution of objects in the region. Based on the first sensor data, the processor 250 determines the positions of the three reflective portions 148a, 148b, and 148c. In the example of FIG. 2, the reflective portions 148a, 148b, and 148c each have a rectangular shape, and may have other shapes. For example, the shape of each of the reflective portions 148a, 148b, and 148c may be elliptical, perfect circular, triangular, or other polygonal, or characteristic shapes such as a star shape or cross shape. The reflective portions 148a, 148b, and 148c may have different shapes. The processor 250 estimates the pose of the second LiDAR sensor 140B relative to the first LiDAR sensor 140A based on the estimated positions of the reflective portions 148a, 148b, and 148c.

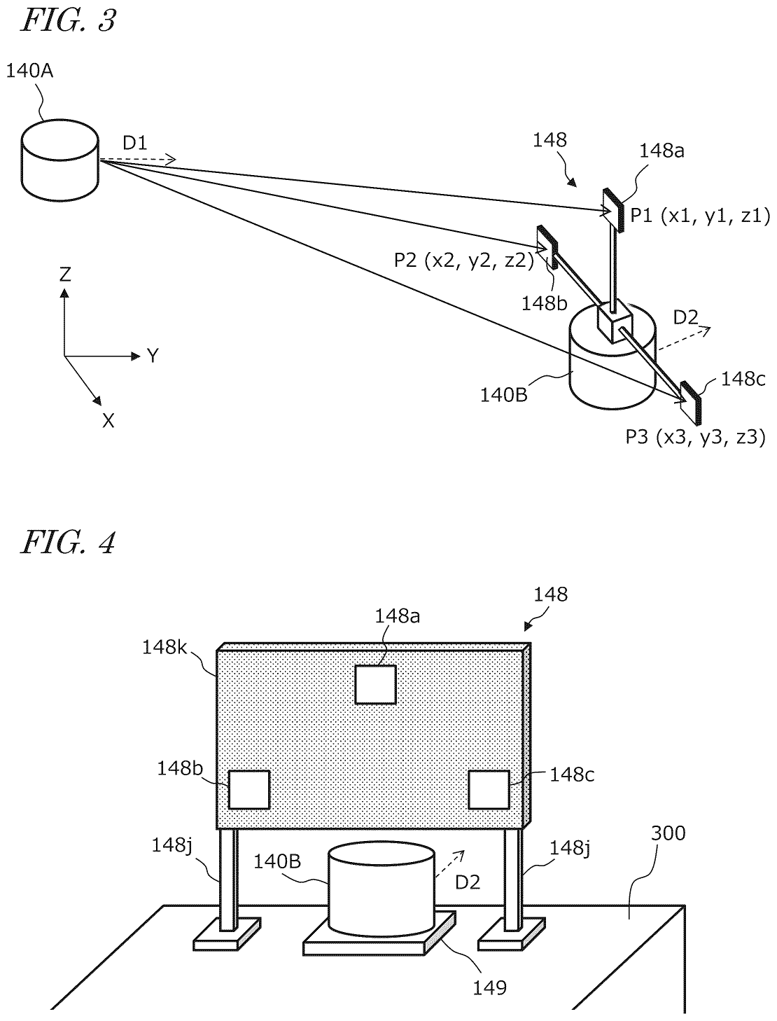

FIG. 3 is a diagram for describing a process of estimating the pose of the second LiDAR sensor 140B relative to the first LiDAR sensor 140A. FIG. 3 illustrates three light beams traveling from the first LiDAR sensor 140A toward the three reflective portions 148a, 148b, and 148c by solid line arrows. In this example, the first LiDAR sensor 140A performs beam scanning around the front direction D1 to measure distances to reflection points of objects existing in a region including the three reflective portions 148a, 148b, and 148c. Based on the distances and directions of the reflection points, the first LiDAR sensor 140A can generate, as the first sensor data, point cloud data including information about the three-dimensional coordinate values of the reflection points in a first sensor coordinate system fixed to the first LiDAR sensor 140A. The first sensor coordinate system is also fixed to the work vehicle 100. FIG. 3 illustrates X, Y, and Z axes that are orthogonal to each other and that define the first sensor coordinate system. The first sensor data may, for example, be point cloud data indicating the correspondence between the identification numbers of a plurality of reflection points for which reflected light is detected, and the coordinate values (x, y, z) of the reflection points. The first sensor data may include information about the luminances of the reflection points.

The processor 250 is configured or programmed to retrieve some reflection points corresponding to the three reflective portions 148a, 148b, and 148c from a plurality of reflection points indicated by the first sensor data output from the first LiDAR sensor 140A. For example, the processor 250 may perform clustering on the point cloud indicated by the first sensor data based on point-to-point distances, and retrieves three clusters that are estimated to indicate the actual positional relationship and shapes of the reflective portions 148a, 148b, and 148c, as reflection points corresponding to the reflective portions 148a, 148b, and 148c. Alternatively, if the first sensor data includes information about the luminance of each reflection point, some reflection points constituting three clusters close to each other, of reflection points whose luminances exceed a threshold, may be retrieved as reflection points corresponding to the three reflective portions 148a, 148b, and 148c.

The processor 250 is configured or programmed to determine a representative position of each of the reflective portions 148a, 148b, and 148c based on the coordinate values of the plurality of retrieved reflection points corresponding to the reflective portions 148a, 148b, and 148c. The representative position of each reflective portion may, for example, be the average value or middle value of the positions of the plurality of reflection points corresponding to the reflective portion. The representative position of each reflective portion is hereinafter referred to as the “position” of the reflective portion.

In the example of FIG. 3, a relationship between the positions of the three reflective portions 148a, 148b, and 148c, and a reference position (e.g., the position of a point from which the beam is emitted) of the second LiDAR sensor 140B and the front direction D2 of the second LiDAR sensor 140B, is known, and data indicating the relationship is previously stored in the storage. The processor 250 is configured or programmed to determine the reference position of the second LiDAR sensor 140B and the front direction D2 in the first sensor coordinate system based on the data indicating the relationship, and the positions of the three reflective portions 148a, 148b, and 148c determined based on the first sensor data.

As illustrated in FIG. 3, it is assumed that the positions of the three reflective portions 148a, 148b, and 148c in the first sensor coordinate system have been determined to be P1 (x1, y1, z1), P2 (x2, y2, z2), and P3 (x3, y3, z3), respectively. In this case, the processor 250 can, for example, determine the reference position of the second LiDAR sensor 140B and the front direction D2 in the first sensor coordinate system using a method described below.

Initially, the processor 250 calculates and determines the position of the median point of the triangle formed by the positions P1, P2, and P3 of the three reflective portions 148a, 148b, and 148c determined based on the first sensor data, and the vector normal to the plane including the positions P1, P2, and P3. The processor 250 determines a position that is located at a predetermined distance away from the determined median point of the triangle in a predetermined direction (e.g., the direction of a vector from the point P1 toward the median point) as the reference position of the second LiDAR sensor 140B. The processor 250 is also configured or programmed to determine the direction of the determined vector normal to the plane as the front direction D2 of the second LiDAR sensor 140B. As a result, the processor 250 can estimate the position and orientation angles (roll, pitch, and yaw) of the second LiDAR sensor 140B. It should be noted that the method for estimating the pose of the second LiDAR sensor 140B depends on a relationship in relative position and orientation between the second LiDAR sensor 140B and the marker 148. For example, if the direction of the line normal to the plane including the three points P1, P2, and P3 of the marker 148 deviates from the front direction D2 of the second LiDAR sensor 140B, the pose of the second LiDAR sensor 140B relative to the first LiDAR sensor 140A is estimated, taking the deviation into account.

The marker 148 may be provided at a position away from the second LiDAR sensor 140B. The positional relationship between the marker 148 and the second LiDAR sensor 140B, and the sizes of the reflective portions, may be adjusted as appropriate. If the first LiDAR sensor 140A and the second LiDAR sensor 140B are located too far away from each other, it may be difficult to detect the reflective portions. Conversely, if the first LiDAR sensor 140A and the second LiDAR sensor 140B are too close to each other, the reflective portions may be located out of the detection range of the first LiDAR sensor 140A. In such cases, by changing the distance between the marker 148 and the second LiDAR sensor 140B or the sizes of the reflective portions, the reflective portions can be appropriately detected.

FIG. 4 is a diagram illustrating another example of the marker 148. In this example, the marker 148 is mounted on the implement 300 separately from the second LiDAR sensor 140B. The marker 148 of FIG. 4 has a flat plate 148k supported by two support posts 148j. The three reflective portions 148a, 148b, and 148c are provided on the flat plate 148k. On the reflective portions 148a, 148b, and 148c, provided is a reflective material (e.g., a retroreflective material) having a higher reflectance with respect to light emitted from the first LiDAR sensor 140A than (e.g., at least two times as high as) that of the flat plate 148k and the support post 148j. The position of the marker 148 can be changed as appropriate. Even in the case in which the marker 148 thus configured is used, the pose of the second LiDAR sensor 140B can be estimated by a process similar to that of the example of FIG. 3.

As described above, in this example embodiment, the processor 250 is configured or programmed to recognize the three reflective portions 148a, 148b, and 148c of the marker 148 provided in the vicinity of the second LiDAR sensor 140B based on the first sensor data output from the first LiDAR sensor 140A. The processor 250 is configured or programmed to estimate the pose of the second LiDAR sensor 140B in a coordinate system fixed to the first LiDAR sensor 140A and the work vehicle 100 based on the recognized positions of the three reflective portions 148a, 148b, and 148c. The processor 250 is configured or programmed to output data indicating the estimated pose of the second LiDAR sensor 140B. For example, the processor 250 may output and store the data indicating the pose of the second LiDAR sensor 140B to the storage. Alternatively, the processor 250 may transmit the data indicating the pose of the second LiDAR sensor 140B to an external computer.

The processor 250 may be configured or programmed to convert the second sensor data output from the second LiDAR sensor 140B into data represented in a vehicle coordinate system fixed to the work vehicle 100 based on the estimated pose of the second LiDAR sensor 140B, and output the resultant data. For example, the processor 250 may I perform the coordinate conversion by performing a matrix operation for translating and rotating the coordinate values of the reflection points in the second sensor data based on the estimate position and orientation angles of the second LiDAR sensor 140B. The processor 250 can generate point cloud data in the vehicle coordinate system by such coordinate conversion. The processor 250 may generate combined point cloud data using not only the second sensor data but also the first sensor data. For example, the processor 250 may convert the second sensor data into data represented in the vehicle coordinate system based on the estimated pose of the second LiDAR sensor 140B, and generate and output point cloud data based on the first sensor data and the converted second sensor data.

Concerning the first LiDAR sensor 140A, calibration has been performed previously (e.g., in a factory prior to shipment), and the relationship in position and orientation between the work vehicle 100 and the first LiDAR sensor 140A is known. Based on the known relationship, the processor 250 can convert the first sensor data represented by the first sensor coordinate system into data represented by the vehicle coordinate system. Alternatively, the processor 250 may process the first sensor coordinate system as the vehicle coordinate system. In that case, the process of coordinate conversion of the first sensor data is not required.

The processor 250 can generate point cloud data by combining the first sensor data represented by the vehicle coordinate system and the second sensor data. In this case, the processor 250 may combine data obtained by excluding, from the first sensor data, data of regions corresponding to the implement 300, the second LiDAR sensor 140B, and the marker 148, with the converted second sensor data, to generate point cloud data. The shapes of the implement 300, the second LiDAR sensor 140B, and the marker 148, and the positional relationship between the implement 300, the second LiDAR sensor 140B, and the marker 148, and the first LiDAR sensor 140A, are known. Based on the known positional relationship, the processor 250 can determine and exclude, from the first sensor data, data of regions corresponding to the implement 300, the second LiDAR sensor 140B, and the marker 148. By such a process, combined point cloud data from which a point cloud corresponding to the implement 300, the second LiDAR sensor 140B, and the marker 148, which is not required for the automatic operation, has been excluded can be generated.

In this example embodiment, the processor 250 itself generates point cloud data based on the first sensor data and the second sensor data. Alternatively, another computer may instead generate the point cloud data. In that case, the processor 250 is configured or programmed to transmit data indicating the estimated pose of the second LiDAR sensor 140B, and the second sensor data (and, in some cases, the first sensor data), to the second computer. The second computer can generate point cloud data indicating the distribution of objects on the ground around the work vehicle 100 based on the data received from the processor 250.

In this example embodiment, the second LiDAR sensor 140B transmits the generated second sensor data to the processor 250 by, for example, wireless communication. The second LiDAR sensor 140B may optionally perform downsampling on the second sensor data, and transmit the second sensor data whose data amount has been compressed to the processor 250. This also holds true for the first LiDAR sensor 140A.

The sensing system of this example embodiment may further include a storage that stores an environmental map. The storage may be internal or external to the processor 250. The environmental map represents the positions or regions of objects existing in an environment in which the work vehicle 100 travels using a predetermined coordinate system. The processor 250 is configured or programmed to perform localization on the work vehicle 100 by the following steps (S1)-(S4).
(S1) Estimating the pose of the second LiDAR sensor 140B by the above process based on the first sensor data.
(S2) Converting, based on the estimated pose, the second sensor data into data represented by the vehicle coordinate system.
(S3) Generating, based on the converted second sensor data, point cloud data indicating the distribution of objects on the ground around the work vehicle 100, wherein the generation of the point cloud data may also be based on first sensor data.
(S4) Estimating the pose of the work vehicle 100 by performing matching between the point cloud data and the environmental map.

The processor 250 may be configured or programmed to repeatedly perform the steps (S1)-(S4) while the work vehicle 100 is traveling, to estimate the pose of the work vehicle 100 at short time intervals (e.g., at least once per second). The processor 250 may transmit data indicating the estimated pose of the work vehicle 100 to the controller that controls the automatic traveling of the work vehicle 100. The controller may control steering and speed based on the estimated pose of the work vehicle 100 and a preset target path. As a result, the automatic traveling of the work vehicle 100 can be embodied.

In the above example, the pose of the second LiDAR sensor 140B is estimated based on the first sensor data output from the first LiDAR sensor 140A. Instead of this configuration, the pose of the second LiDAR sensor 140B may be estimated using other types of sensing devices.

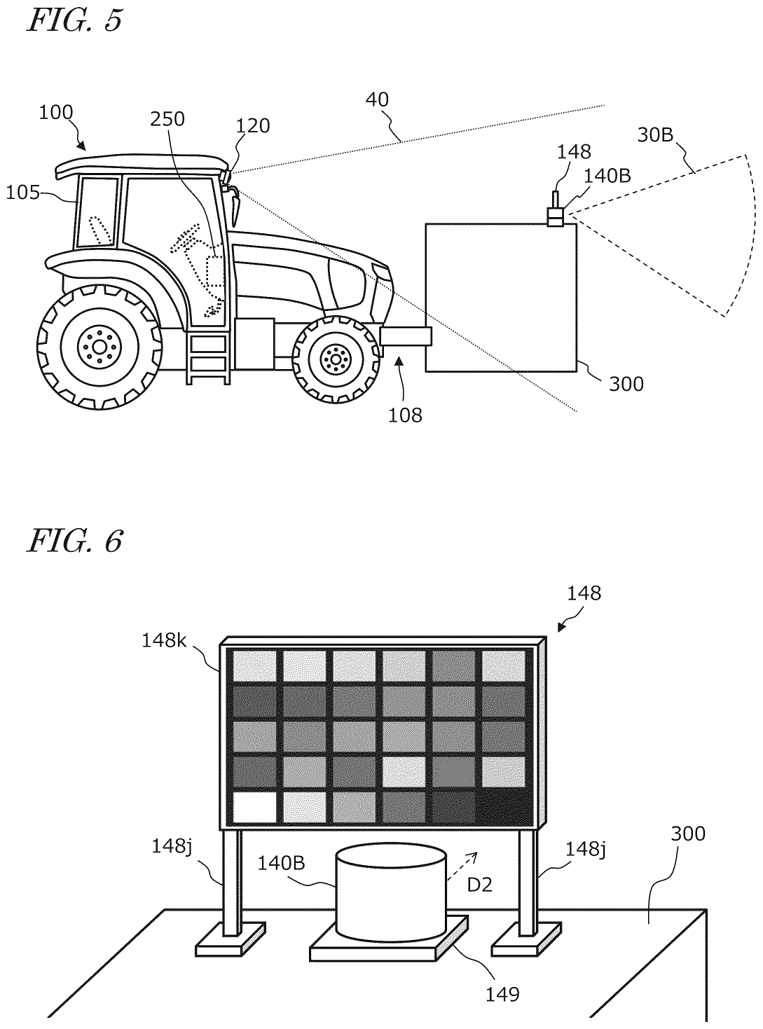

FIG. 5 is a diagram illustrating another example sensing system. In the example of FIG. 5, a camera 120 is provided instead of the first LiDAR sensor 140A of FIG. 1. The camera 120 includes an image sensor to output image data as first sensor data. In this example, the camera 120 or the image sensor serves as a first range sensor. FIG. 5 illustrates an imaging range 40 of the camera 120 with a dotted line. In this example, a marker 148 has a characteristic luminance distribution or color distribution. The processor 250 estimates the pose of the LiDAR sensor 140B relative to the camera 120 based on the luminance distribution or color distribution of a region corresponding to the marker 148 in the image indicated by the first sensor data. For example, in the case in which the marker 148 includes three reflective portions 148a, 148b, and 148c such as those illustrated in FIG. 4, distances to the reflective portions 148a, 148b, and 148c can be estimated from the sizes of the reflective portions 148a, 148b, and 148c, respectively, recognized from the image data. Based on the estimated distances to the reflective portions 148a, 148b, and 148c, the processor 250 can estimate the position and orientation angles of the LiDAR sensor 140B as viewed from the camera 120.

The marker 148 may include a plurality of portions (e.g., at least three portions) with different colors instead of the reflective portions 148a, 148b, and 148c, which have a high light reflectance. FIG. 6 is a diagram illustrating an example of the marker 148 including a plurality of portions with different colors. In FIG. 6, the marker 148 includes a flat plate 148k on which a color chart having a plurality of portions having different colors is provided. The processor 250 can estimate distances to the portions based on the sizes and positional relationship of the plurality of portions having different colors in an image generated by the camera 120 imaging a scene including the marker 148. The processor 250 can estimate the pose of the second LiDAR sensor 140B based on the distances to the portions.

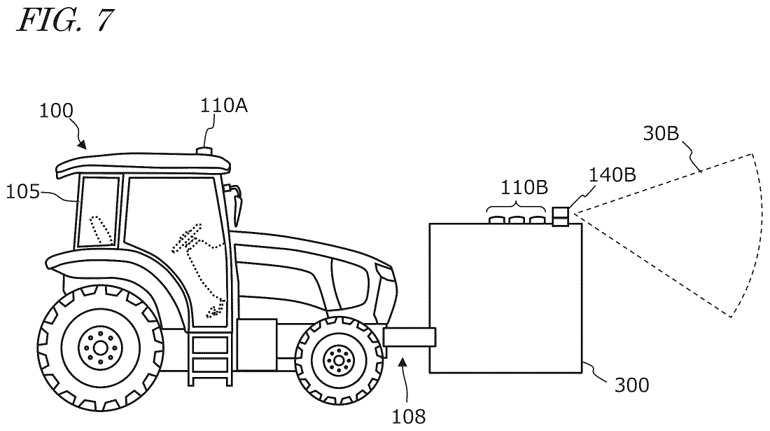

FIG. 7 is a diagram illustrating still another example sensing system. In the example of FIG. 7, the work vehicle 100 is provided with a first GNSS receiver 110A. The implement 300 is provided with at least three second GNN receivers 110B and a LiDAR sensor 140B. The work vehicle 100 is not provided with a LiDAR sensor.

The first GNSS receiver 110A is provided at an upper portion of the cabin 105. The second GNN receiver 110B is arranged on the implement 300 around the LiDAR sensor 140B with a space therebetween. The GNN receivers 110A and 110B may each be provided at a position different from that of FIG. 7. The GNN receivers 110A and 110B may each include an antenna that receives signals from GNSS satellites, and a processor configured or programmed to calculate its own position based on the signals received by the antenna. The GNN receivers 110A and 110B each receive satellite signals transmitted from a plurality of GNSS satellites, and perform positioning based on the satellite signals. GNSS collectively refers to satellite-based positioning systems, such as the global positioning system (GPS), the quasi-zenith satellite system (QZSS, for example, Michibiki), GLONASS, Galileo, and BeiDou.

The processor 250 may be connected to each of the GNN receivers 110A and 110B by wireless or wired communication. The processor 250 is configured or programmed to estimate the pose of the LiDAR sensor 140B relative to the first GNSS receiver 110A based on satellite signals received from the first GNSS receiver 110A and satellite signals received by the at least three second GNN receivers 110B. For example, the processor 250 can calculate the position of each second GNN receiver 110B relative to the first GNSS receiver 110A by performing moving baseline processing where the first GNSS receiver 110A is a moving base, and the plurality of second GNN receiver 110B are a rover. A positional relationship between each second GNN receiver 110B and the LiDAR sensor 140B is known, and data indicating the positional relationship is stored in a storage. The processor 250 can estimate the pose of the second LiDAR sensor 140B based on the calculated position of each second GNN receiver 110B and the known positional relationship between each second GNN receiver 110B and the LiDAR sensor 140B. It should be noted that the above process executed by the processor 250 may be executed by a processor included in the first GNSS receiver 110A.

Next, a more specific example in which the work vehicle 100 automatically travels while performing localization using a sensing system will be described.

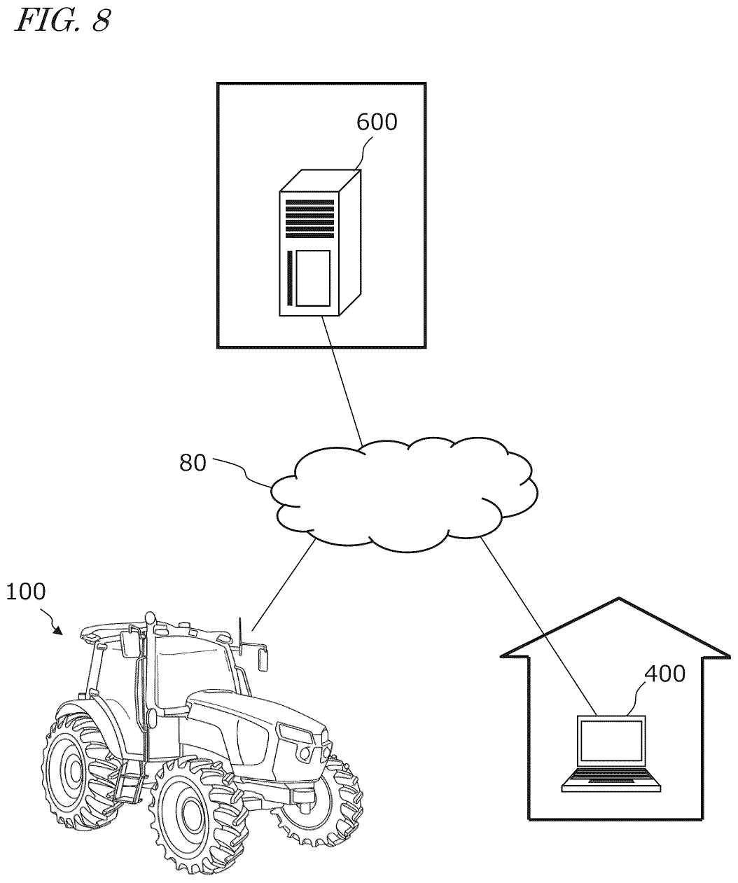

FIG. 8 is a diagram for outlining a system according to an illustrative example embodiment of the present disclosure. The system of FIG. 8 includes a work vehicle 100, a terminal device 400, and a management device 600. The terminal device 400 is a computer used by a user who remotely monitors the work vehicle 100. The management device 600 is a computer managed by an entity running the system. The work vehicle 100, the terminal device 400, and the management device 600 can communicate with each other through a network 80. Although FIG. 8 illustrates a single work vehicle 100, the system may include a plurality of work vehicles or other agricultural machines.

The work vehicle 100 according to the present example embodiment is a tractor. The work vehicle 100 can have an implement attached to its rear and/or its front. While performing agricultural work in accordance with a particular type of implement, the work vehicle 100 is able to travel inside a field. The work vehicle 100 may travel inside the field or outside the field with no implement being attached thereto.

The work vehicle 100 has a self-driving function. In other words, the work vehicle 100 can travel by the action of a controller, rather than manually. The controller according to the present example embodiment is provided inside the work vehicle 100, and is able to control both the speed and steering of the work vehicle 100. The work vehicle 100 can perform self-traveling outside the field (e.g., on roads) as well as inside the field.

The work vehicle 100 includes a device usable for positioning or localization, such as a GNSS receiver or an LiDAR sensor. Based on the position of the work vehicle 100 and information on a target path, the controller of the work vehicle 100 causes the work vehicle 100 to automatically travel. In addition to controlling the travel of the work vehicle 100, the controller also controls the operation of the implement. As a result, while automatically traveling inside the field, the work vehicle 100 is able to perform agricultural work by using the implement. In addition, the work vehicle 100 is able to automatically travel along the target path on a road outside the field (e.g., an agricultural road or a general road). In the case of performing self-traveling on a road outside the field, the work vehicle 100 travels while generating, along the target path, a local path along which the work vehicle 100 can avoid an obstacle, based on data output from a sensing device such as a camera or a LiDAR sensor. Inside the field, the work vehicle 100 may travel while generating a local path in substantially the same manner as described above, or may perform an operation of traveling along the target path without generating a local path and halting when an obstacle is detected.

The management device 600 is a computer to manage the agricultural work performed by the work vehicle 100. The management device 600 may be, for example, a server computer that performs centralized management on information regarding the field on the cloud and supports agriculture by use of the data on the cloud. The management device 600, for example, creates a work plan for the work vehicle 100 and performs path planning for the work vehicle 100 in accordance with the work plan. The management device 600 may further generate or edit an environment map based on data collected by the work vehicle 100 or any other movable body by use of the sensing device such as a LiDAR sensor. The management device 600 transmits data on the work plan, the target path and the environment map thus generated to the work vehicle 100. The work vehicle 100 automatically moves and performs agricultural work based on the data.

The terminal device 400 is a computer that is used by a user who is located away from the work vehicle 100. The terminal device 400 is used to remotely monitor the work vehicle 100 or remotely operate the work vehicle 100. For example, the terminal device 400 can display, on a display device, video captured by at least one camera (imaging device) provided in the work vehicle 100. The user can check a situation around the work vehicle 100 by viewing the video, and sends a stop or start instruction to the work vehicle 100.

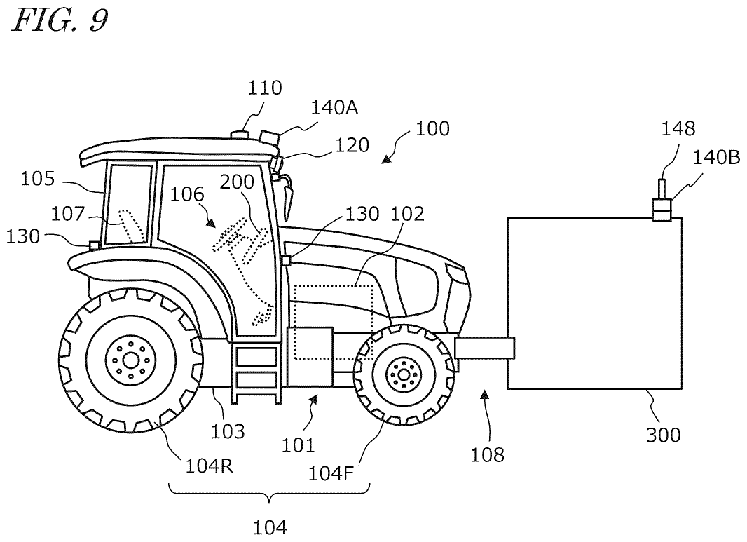

FIG. 9 is a side view schematically showing an example of the work vehicle 100 and an example of implement 300 linked to the work vehicle 100. The work vehicle 100 according to the present example embodiment can operate both in a manual driving mode and a self-driving mode. In the self-driving mode, the work vehicle 100 is able to perform unmanned travel.

The work vehicle 100 of FIG. 9 includes a vehicle body 101, a prime mover (engine) 102, and a transmission 103. The vehicle body 101 is provided with tire-mounted wheels 104 and a cabin 105. The wheels 104 include a pair of front wheels 104F and a pair of rear wheels 104R. In the cabin 105, a driver's seat 107, a steering device 106, an operation terminal 200, and switches for operations are provided. One or both of the front wheel 104F and the rear wheel 104R may be replaced with a plurality of wheels to which a continuous track is attached (crawler) instead of a tire-mounted wheel.

The work vehicle 100 includes a plurality of sensing devices that sense surroundings of the work vehicle 100. In the example of FIG. 9, the sensing devices include a camera 120, a first LiDAR sensor 140A, and a plurality of obstacle sensors 130. A second LiDAR sensor 140B and a marker 148 are mounted on an implement 300.

The camera 120 captures an image of an environment around the work vehicle 100 to generate image data. The work vehicle 100 may be provided with a plurality of cameras 120. An image obtained by the camera 120 may be transmitted to the terminal device 400, which performs remote monitoring. The image may be used to monitor the work vehicle 100 during unmanned driving. The camera 120 may also be used to generate images for recognizing surrounding objects or obstacles on the ground, white lines, signs, displays, and the like when the work vehicle 100 travels on roads (agricultural roads or general roads) outsides the field.

The first LiDAR sensor 140A is arranged on the cabin 105. The second LiDAR sensor 140B is arranged on the implement 300. The first LiDAR sensor 140A and the second LiDAR sensor 140B may each be provided at a position different from that illustrated in the figures. The first LiDAR sensor 140A and the second LiDAR sensor 140B each repeatedly output first sensor data indicating distances to and directions of measurement points of objects existing in a surrounding environment, or the two-dimensional or three-dimensional coordinate values of the measurement points, while the work vehicle 100 is traveling.

The first sensor data output from the first LiDAR sensor 140A and the second sensor data output from the second LiDAR sensor 140B are processed by a processor in the work vehicle 100. The processor estimates the pose of the second LiDAR sensor 140B relative to the first LiDAR sensor 140A based on the first sensor data generated by the first LiDAR sensor 140A sensing a region including the marker 148. The processor is configured or programmed to convert the second sensor data into data represented by a vehicle coordinate system fixed to the work vehicle 100, based on the estimated pose of the second LiDAR sensor 140B. Based on the converted second sensor data, or by combining the converted the converted second sensor data with the first sensor data, the processor generates point cloud data in the vehicle coordinate system. The processor can perform localization on the work vehicle 100 by performing matching between the point cloud data and an environmental map. The processor can also, for example, generate or edit an environmental map using an algorithm such as simultaneous localization and mapping (SLAM). The work vehicle 100 and the implement 300 may include a plurality of LiDAR sensors arranged at different positions and different orientations.

The plurality of obstacle sensors 130 shown in FIG. 9 are provided at the front and the rear of the cabin 105. The obstacle sensors 130 may be disposed at other positions. For example, one or more obstacle sensors 130 may be disposed at any position at the sides, the front or the rear of the vehicle body 101. The obstacle sensors 130 may include, for example, a laser scanner or an ultrasonic sonar. The obstacle sensors 130 may be used to detect obstacles in the surroundings of the work vehicle 100 during self-traveling to cause the work vehicle 100 to halt or detour around the obstacles. The LiDAR sensor 140 may be used as one of the obstacle sensors 130.

The work vehicle 100 further includes a GNSS unit 110. The GNSS unit 110 includes a GNSS receiver. The GNSS receiver may include an antenna to receive a signal(s) from a GNSS satellite(s) and a processor to calculate the position of the work vehicle 100 based on the signal(s) received by the antenna. The GNSS unit 110 receives satellite signals transmitted from the plurality of GNSS satellites, and performs positioning based on the satellite signals. Although the GNSS unit 110 according to the present example embodiment is disposed above the cabin 105, it may be disposed at any other position.

The GNSS unit 110 may include an inertial measurement unit (IMU). Signals from the IMU can be used to complement position data. The IMU can measure a tilt or a small motion of the work vehicle 100. The data acquired by the IMU can be used to complement the position data based on the satellite signals, so as to improve the performance of positioning.

The controller of the work vehicle 100 may utilize, for positioning, the sensing data acquired by the sensing devices such as the cameras 120 or the LIDAR sensor 140, in addition to the positioning results provided by the GNSS unit 110. In the case where objects serving as characteristic points exist in the environment that is traveled by the work vehicle 100, as in the case of an agricultural road, a forest road, a general road or an orchard, the position and the orientation of the work vehicle 100 can be estimated with a high accuracy based on data that is acquired by the cameras 120 or the LiDAR sensor 140 and on an environment map that is previously stored in the storage. By correcting or complementing position data based on the satellite signals using the data acquired by the cameras 120 or the LiDAR sensor 140, it becomes possible to identify the position of the work vehicle 100 with a higher accuracy.

The prime mover 102 may be a diesel engine, for example. Instead of a diesel engine, an electric motor may be used. The transmission 103 can change the propulsion and the moving speed of the work vehicle 100 through a speed changing mechanism. The transmission also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the work vehicle 100. The steering angle of the front wheels 104F can be changed by manipulating the steering wheel. The power steering device includes a hydraulic device or an electric motor to supply an assisting force to change the steering angle of the front wheels 104F. When automatic steering is performed, under the control of the controller disposed in the work vehicle 100, the steering angle may be automatically adjusted by the power of the hydraulic device or the electric motor.

A linkage device 108 is provided at the front of the vehicle body 101. The linkage device 108 may include, e.g., a three-point linkage (also referred to as a “three-point link” or a “three-point hitch”), a PTO (Power Take Off) shaft, a universal joint, and a communication cable. The linkage device 108 allows the implement 300 to be attached to, or detached from, the work vehicle 100. The linkage device 108 is able to raise or lower the three-point link with a hydraulic device, for example, thus changing the position and/or attitude of the implement 300. Moreover, motive power can be sent from the work vehicle 100 to the implement 300 via the universal joint. The linkage device may also be provided at a rear portion of the vehicle body 101. In that case, an implement can be connected at the back of the work vehicle 100.

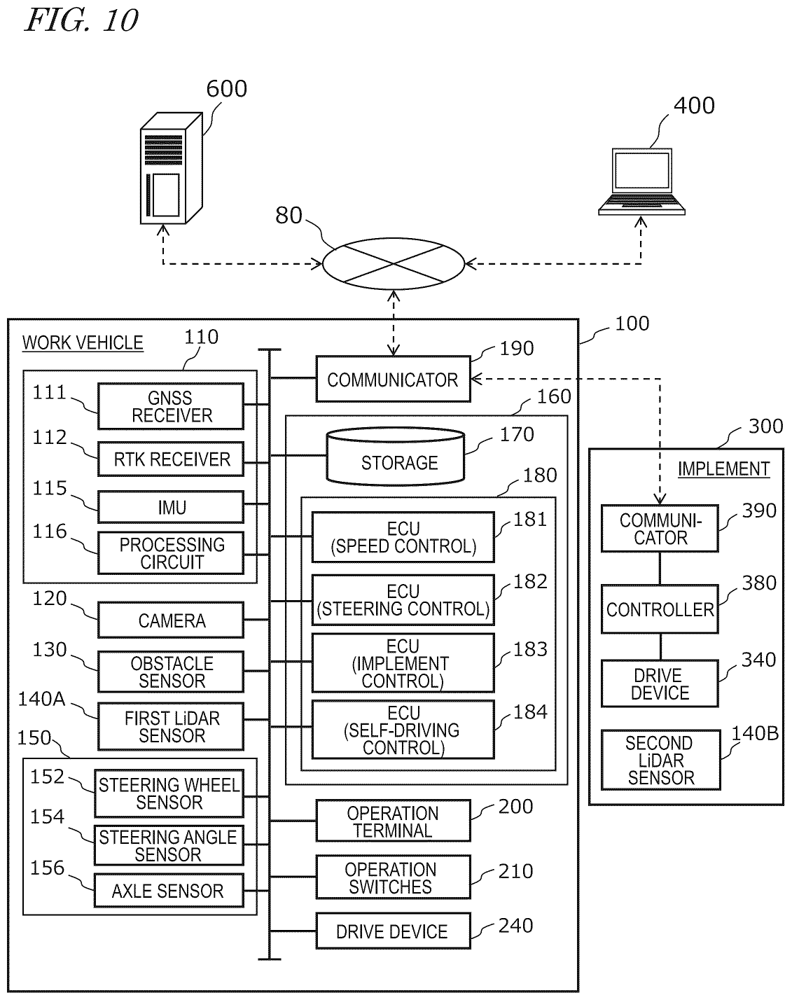

FIG. 10 is a block diagram showing example configuration of the work vehicle 100 and the implement 300. The work vehicle 100 and the implement 300 can communicate with each other via a communication cable that is included in the linkage device 108. The work vehicle 100 is able to communicate with the terminal device 400 and the management device 600 via the network 80.

In addition to the GNSS unit 110, the cameras 120, the obstacle sensors 130, the first LiDAR sensor 140A and the operation terminal 200, the work vehicle 100 in the example of FIG. 10 includes sensors 150 to detect the operating status of the work vehicle 100, a control system 160, a communicator 190, operation switches 210, and a drive device 240. These component elements are communicably connected to each other via a bus. The GNSS unit 110 includes a GNSS receiver 111, an RTK receiver 112, an inertial measurement unit (IMU) 115, and a processing circuit 116. The sensors 150 include a steering wheel sensor 152, an steering angle sensor 154, and a wheel axis sensor 156. The control system 160 includes a storage 170 and a controller 180. The controller 180 includes a plurality of electronic control units (ECU) 181 to 184. The implement 300 includes a drive device 340, a controller 380, a communicator 390, and a second LiDAR sensor 140B. Note that FIG. 10 shows component elements which are relatively closely related to the operations of self-driving by the work vehicle 100, while other components are omitted from illustration.

The GNSS receiver 111 in the GNSS unit 110 receives satellite signals the plurality transmitted from of GNSS satellites and generates GNSS data based on the satellite signals. The GNSS data is generated in a predetermined format such as, for example, the NMEA-0183 format. The GNSS data may include, for example, the identification number, the angle of elevation, the angle of direction, and a value representing the reception strength of each of the satellites from which the satellite signals are received.

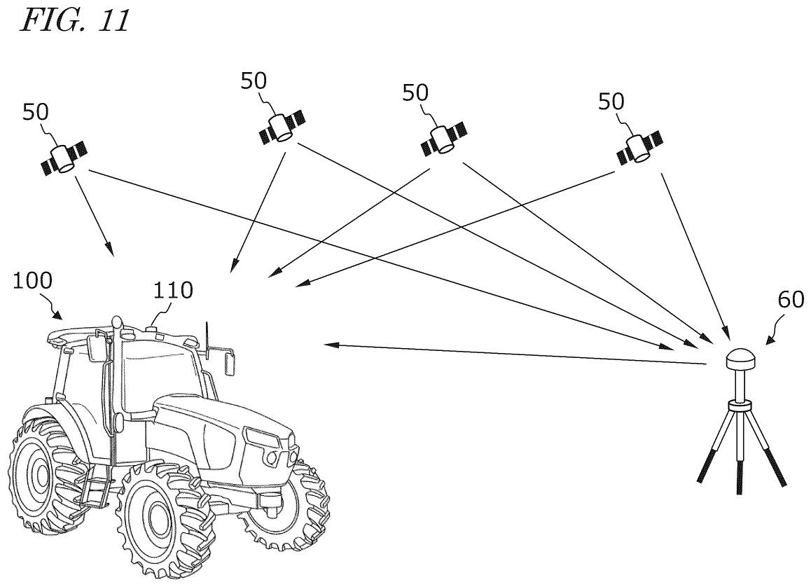

The GNSS unit 110 shown in FIG. 10 may be configured to perform positioning of the work vehicle 100 by utilizing an RTK (Real Time Kinematic)-GNSS, for example. FIG. 11 is a conceptual diagram showing an example of the work vehicle 100 performing positioning based on the RTK-GNSS. In the positioning based on the RTK-GNSS, not only satellite signals transmitted from a plurality of GNSS satellites 50, but also a correction signal that is transmitted from a reference station 60 is used. The reference station 60 may be disposed near the field where the work vehicle 100 performs tasked travel (e.g., at a position within 10 km of the work vehicle 100). The reference station 60 generates a correction signal of, for example, an RTCM format based on the satellite signals received from the plurality of GNSS satellites 50, and transmits the correction signal to the GNSS unit 110. The RTK receiver 112, which includes an antenna and a modem, receives the correction signal transmitted from the reference station 60. Based on the correction signal, the processing circuit 116 of the GNSS unit 110 corrects the results of the positioning performed by use of the GNSS receiver 111. Use of the RTK-GNSS enables positioning with an accuracy on the order of several centimeters of errors, for example. Positional information including latitude, longitude, and altitude information is acquired through the highly accurate positioning by the RTK-GNSS. The GNSS unit 110 calculates the position of the work vehicle 100 as frequently as, for example, one to ten times per second.

Note that the positioning method is not limited to being performed by use of an RTK-GNSS, any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System). In the case where positional information with the necessary accuracy can be obtained without the use of the correction signal transmitted from the reference station 60, positional information may be generated without using the correction signal. In that case, the GNSS unit 110 does not need to include the RTK receiver 112.

Even in the case where the RTK-GNSS is used, at a site where the correction signal from the reference station 60 cannot be acquired (e.g., on a road far from the field), the position of the work vehicle 100 is estimated by another method with no use of the signal from the RTK receiver 112. For example, the position of the work vehicle 100 may be estimated by matching the data output from the LiDAR sensors 140A and 140B and/or the cameras 120 against a highly accurate environment map.

The GNSS unit 110 according to the present example embodiment further includes the IMU 115. The IMU 115 may include a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the GNSS unit 110.

The cameras 120 are imagers that image the surrounding environment of the work vehicle 100. Each of the cameras 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the surrounding environment of the work vehicle 100, and generate image data (e.g., motion picture data). The cameras 120 are able to capture motion pictures at a frame rate of 3 frames/second (fps: frames per second) or greater, for example. The images generated by the cameras 120 may be used by a remote supervisor to check the surrounding environment of the work vehicle 100 with the terminal device 400, for example. The images generated by the cameras 120 may also be used for the purpose of positioning and/or detection of obstacles. A single camera 120 may be provided, or a plurality of cameras 120 may be provided at different positions on the work vehicle 100. A visible camera(s) to generate visible light images and an infrared camera(s) to generate infrared images may be separately provided. Both of a visible camera(s) and an infrared camera(s) may be provided as cameras for generating images for monitoring purposes. The infrared camera(s) may also be used for detection of obstacles at nighttime. The camera(s) 120 may be a stereo camera. The stereo camera can be used to obtain a distance image indicating a distance distribution in the imaging range.

The obstacle sensors 130 detect objects existing in the surroundings of the work vehicle 100. Each of the obstacle sensors 130 may include a laser scanner or an ultrasonic sonar, for example. When an object exists at a position within a predetermined distance from one of the obstacle sensors 130, the obstacle sensor 130 outputs a signal indicating the presence of the obstacle. The plurality of obstacle sensors 130 may be provided at different positions on the work vehicle 100. For example, a plurality of laser scanners and a plurality of ultrasonic sonars may be disposed at different positions on the work vehicle 100. Providing such a great number of obstacle sensors 130 can reduce blind spots in monitoring obstacles in the surroundings of the work vehicle 100. The steering wheel sensor 152 measures the angle of

rotation of the steering wheel of the work vehicle 100. The steering angle sensor 154 measures the angle of turn of the front wheels 104F, which are the wheels responsible for steering. Measurement values by the steering wheel sensor 152 and the steering angle sensor 154 are used for steering control by the controller 180.

The wheel axis sensor 156 measures the rotational speed, i.e., the number of revolutions per unit time, of a wheel axis that is connected to the wheels 104. The wheel axis sensor 156 may be a sensor including a magnetoresistive element (MR), a Hall generator, or an electromagnetic pickup, for example. The wheel axis sensor 156 outputs a numerical value indicating the number of revolutions per minute (unit: rpm) of the wheel axis, for example. The wheel axis sensor 156 is used to measure the speed of the work vehicle 100.

The drive device 240 includes various types of devices required to cause the work vehicle 100 to travel and to drive the implement 300. For example, the prime mover 102, the transmission 103, and the steering device 106, and the like described above. The prime mover 102 may include an internal combustion engine such as, for example, a diesel engine. The drive device 240 may include an electric motor for traction instead of, or in addition to, the internal combustion engine.

The storage 170 includes one or more storage mediums such as a flash memory or a magnetic disc. The storage 170 stores various data that is generated by the GNSS unit 110, the cameras 120, the obstacle sensors 130, the LiDAR sensor 140, the sensors 150, and the controller 180. The data that is stored by the storage 170 may include map data on the environment where the work vehicle 100 travels (environment map), data on a target path for self-driving, and data indicating a positional relationship between the second LiDAR sensor 140B and the marker 148. The environment map includes information on a plurality of fields where the work vehicle 100 performs agricultural work and roads around the fields. The environment map and the target path may be generated by a processor in the management device 600. The controller 180 may have the function of generating or editing the environmental map and the target path. The storage 170 also stores a computer program(s) to cause each of the ECUs in the controller 180 to perform various operations described below. Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 includes the plurality of ECUs. The plurality of ECUs include, for example, the ECU 181 for speed control, the ECU 182 for steering control, the ECU 183 for implement control, and the ECU 184 for self-driving control.

The ECU 181 controls the prime mover 102, the transmission 103 and brakes included in the drive device 240, thus controlling the speed of the work vehicle 100.

The ECU 182 controls the hydraulic device or the electric motor included in the steering device 106 based on a measurement value of the steering wheel sensor 152, thus controlling the steering of the work vehicle 100.

In order to cause the implement 300 to perform a desired operation, the ECU 183 controls the operations of the three-point link, the PTO shaft and the like that are included in the linkage device 108. Also, the ECU 183 generates a signal to control the operation of the implement 300, and transmits this signal from the communicator 190 to the implement 300.

The ECU 184 serves as the above processor. The ECU 184 performs computation and control for achieving self-driving based on data output from the GNSS unit 110, the cameras 120, the obstacle sensors 130, the first LiDAR sensor 140A, the sensors 150, and the second LiDAR sensor 140B. For example, the ECU 184 specifies the position of the work vehicle 100 based on the data output from at least one of the GNSS unit 110, the cameras 120 and the LiDAR sensors 140A and 140B. In an environment in which the GNSS unit 110 can satisfactorily receive satellite signals, the ECU 184 may determine the position of the work vehicle 100 based only on the data output from the GNSS unit 110. Conversely, in an environment in which there is an obstacle (e.g., a tree or construction) that blocks reception of satellite signals around the work vehicle 100, the ECU 184 may estimate the position of the work vehicle 100 based on data output from the LiDAR sensors 140A and 140B. For example, the ECU 184 may perform localization on the work vehicle 100 by performing matching between data output from the LiDAR sensors 140A and 140B and an environmental map. During self-driving, the ECU 184 performs computation necessary for the work vehicle 100 to travel along a predetermined target path, based on the estimated position of the work vehicle 100. The ECU 184 sends the ECU 181 a command to change the speed, and sends the ECU 182 a command to change the steering angle. In response to the command to change the speed, the ECU 181 controls the prime mover 102, the transmission 103 or the brakes to change the speed of the work vehicle 100. In response to the command to change the steering angle, the ECU 182 controls the steering device 106 to change the steering angle.

Through the actions of these ECUs, the controller 180 realizes self-driving. During self-driving, the controller 180 controls the drive device 240 based on the measured or estimated position of the work vehicle 100 and on the target path. As a result, the controller 180 can cause the work vehicle 100 to travel along the target path.

The plurality of ECUs included in the controller 180 can communicate with each other in accordance with a vehicle bus standard such as, for example, a CAN (Controller Area Network). Instead of the CAN, faster communication methods such as Automotive Ethernet (registered trademark) may be used. Although the ECUs 181 to 184 are illustrated as individual blocks in FIG. 10, the function of each of the ECU 181 to 184 may be implemented by a plurality of ECUs. Alternatively, an onboard computer that integrates the functions of at least some of the ECUs 181 to 184 may be provided. The controller 180 may include ECUs other than the ECUs 181 to 184, and any number of ECUs may be provided in accordance with functionality. Each ECU includes one or more processors.

The communicator 190 is a device including a circuit communicating with the implement 300, the terminal device 400 and the management device 600. The communicator 190 includes circuitry to perform exchanges of signals complying with an ISOBUS standard such as ISOBUS-TIM, example, between itself and the for communicator 390 of the implement 300. This allows the implement 300 to perform a desired operation, or allows information to be acquired from the implement 300. The communicator 190 may also have the function of wirelessly communicating with the second LiDAR sensor 140B. Communication conforming to any wireless communication standard, such as Wi-Fi (registered trademark), cellular mobile communication (e.g., 3G, 4G, or 5G), or Bluetooth (registered trademark), may be performed between the communicator 190 and the second LiDAR sensor 140B. The communicator 190 may further include an antenna and a communication circuit to exchange signals via the network 80 with communicators of the terminal device 400 and the management device 600. The network 80 may include a 3G, 4G, 5G, or any other cellular mobile communications network and the Internet, for example.

The operation terminal 200 is a terminal for the user to perform a manipulation related to the travel of the work vehicle 100 and the operation of the implement 300, and is also referred to as a virtual terminal (VT). The operation terminal 200 may include a display device such as a touch screen panel, and/or one or more buttons. The display device may be a display such as a liquid crystal display or an organic light-emitting diode (OLED) display, for example. By manipulating the operation terminal 200, the user can perform various manipulations, such as, for example, switching ON/OFF the self-driving mode, recording or editing an environment map, setting a target path, and switching ON/OFF the implement 300. At least a portion of these manipulations may also be realized by manipulating the operation switches 210. The operation terminal 200 may be configured so as to be detachable from the work vehicle 100. A user who is at a remote place from the work vehicle 100 may manipulate the detached operation terminal 200 to control the operation of the work vehicle 100. Instead of the operation terminal 200, the user may manipulate a computer on which necessary application software is installed, for example, the terminal device 400, to control the operation of the work vehicle 100.

The drive device 340 in the implement 300 shown in FIG. 10 performs operations necessary for the implement 300 to perform predetermined work. The drive device 340 includes a device suitable for uses of the implement 300, for example, a hydraulic device, an electric motor, a pump or the like. The controller 380 controls the operation of the drive device 340. In response to a signal that is transmitted from the work vehicle 100 via the communicator 390, the controller 380 causes the drive device 340 to perform various operations. Moreover, a signal that is in accordance with the state of the implement 300 can be transmitted from the communicator 390 to the work vehicle 100.

Next, an example automatic traveling operation of the work vehicle 100 will be described.

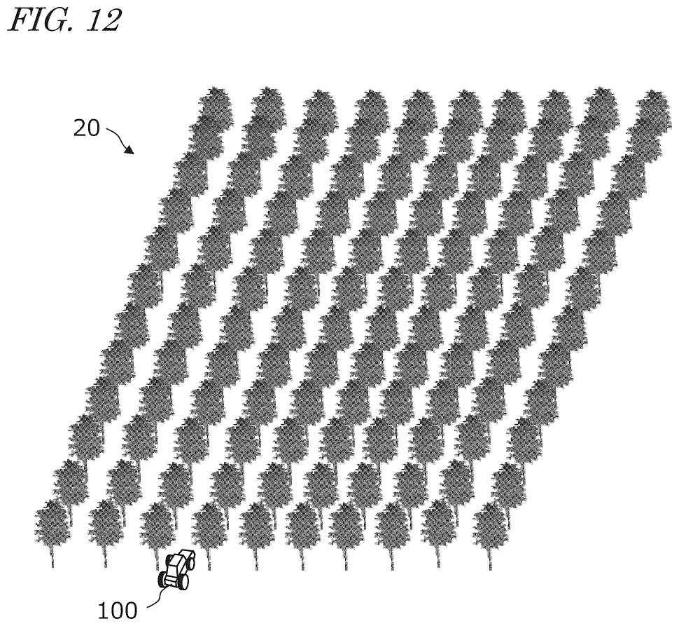

FIG. 12 is a diagram schematically illustrating an example of an environment in which the work vehicle 100 travels. In this example, the work vehicle 100 performs predetermined work (e.g., mowing and pest controlling) using the implement 300 while traveling between a plurality of rows 20 of trees in an orchard (e.g., a grape orchard). In orchards, it is difficult for the work vehicle 100 to perform automatic traveling using GNSS because the work vehicle 100 is hidden by branches and leaves above the work vehicle 100. In such an environment, the ECU 184 performs localization on the work vehicle 100 based on data from the first LiDAR sensor 140A and the second LiDAR sensor 140B.

An example operation of the work vehicle 100 will be specifically described below. The ECU 184 initially generates an environmental map indicating the distribution of trunks of the tree rows 20 in all or a portion of an orchard by utilizing sensor data output from the LiDAR sensors 140A and 140B, and stores the environmental map into the storage 170. The environmental map generation is executed by repeatedly performing localization and generation of a local map. The ECU 184 repeatedly performs the operation of, based on sensor data repeatedly output from the LiDAR sensors 140A and 140B when the work vehicle 100 is traveling, detecting tree rows in an environment around the work vehicle 100 while performing localization, generating a local map indicating the distribution of the detected tree rows, and storing the local map into the storage 170. The ECU 184 generates an environmental map by joining together local maps generated while the work vehicle 100 is traveling in all or a part of an orchard. The environmental map is data in which the distribution of the tree rows 20 in the environment is stored in a form with which the tree rows 20 can be distinguished from other objects. Thus, in this example embodiment, the tree rows 20 may be used as a landmark for SLAM.

After an environmental map has been generated, the work vehicle 100 is allowed to automatically travel. The ECU 184 estimates the position of the work vehicle 100 by detecting the tree rows 20 in the surrounding environment based on sensor data repeatedly output from the LiDAR sensors 140A and 140B when the work vehicle 100 is traveling, and performing matching between the detected tree rows 20 and the environmental map. The ECU 184 controls the traveling of the work vehicle 100 based the estimated position of the work vehicle 100. For example, if the work vehicle 100 deviates from a target path set between two adjacent tree rows, the ECU 184 performs control so as to cause the ECU 182 to adjust the steering of the work vehicle 100 so that the work vehicle 100 approaches the target path. Such steering control may be performed based on the orientation of the work vehicle 100 in addition to the position of the work vehicle 100.

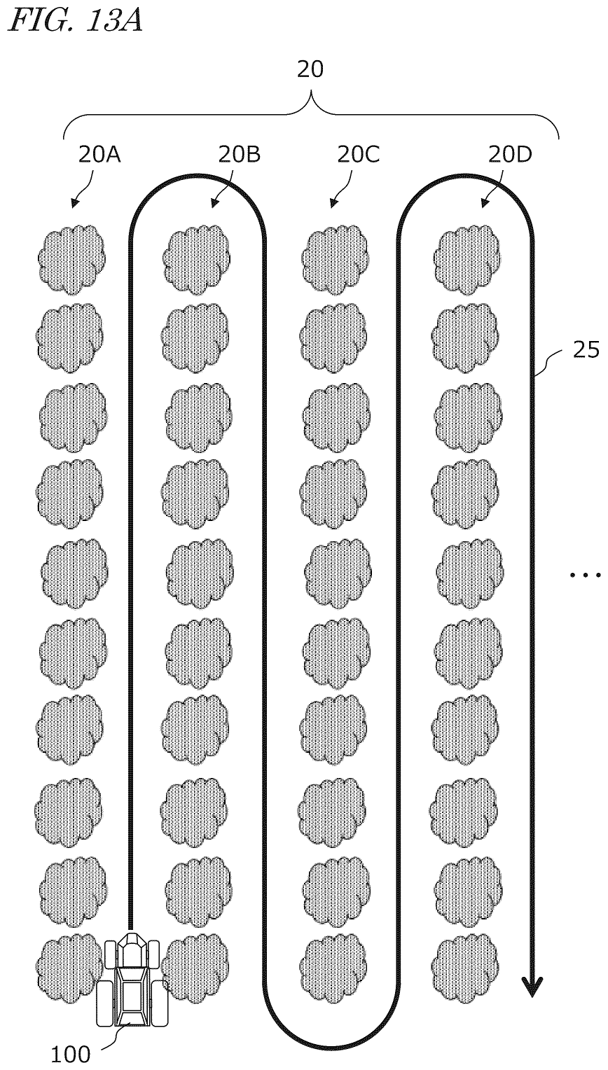

FIG. 13A is a diagram schematically illustrating an example travel path of the work vehicle 100. For example, the work vehicle 100 travels between a plurality of tree rows 20 in an orchard along a path 25 indicated by an arrow in FIG. 13A. Although FIG. 13A illustrates line segments included in the path 25 in straight line, paths along which the work vehicle 100 actually travels may include winding portions. Here, the plurality of tree rows 20 are successively ordered from an end like a first tree row 20A, a second tree row 20B, a third tree row 20C, a fourth tree row 20D, and so on. In the example of FIG. 13A, the work vehicle 100 initially travels between the first tree row 20A and the second tree row 20B, and after that, turns to travel between the second tree row 20B and the third tree row 20C in the opposite direction. After having traveled between the second tree row 20B and the third tree row 20C, the work vehicle 100 turns to travel between the third tree row 20C and the fourth tree row 20D. Thereafter, by repeatedly performing a similar operation, the work vehicle 100 travels to the end of the path 25 between the final two tree rows. It should be noted that as illustrated in FIG. 13B, if adjacent tree rows are separated by a short distance, the work vehicle 100 may travel along every other row. In that case, after having traveled between the final two tree rows, the work vehicle 100 travels along paths between tree rows on which the work vehicle 100 has not yet traveled, along every other row. The work vehicle 100 automatically performs such traveling while performing localization using the LiDAR sensors 140A and 140B. It should be noted that when the GNSS unit 110 can receive GNSS positioning may be performed based on the GNSS signals. For example, in the case of the path 25 illustrated in FIGS. 13A and 13B, when the work vehicle 100 changes directions, the work vehicle 100 is not hidden by leaves that block GNSS signals, and therefore, positioning can be performed based on GNSS signals.

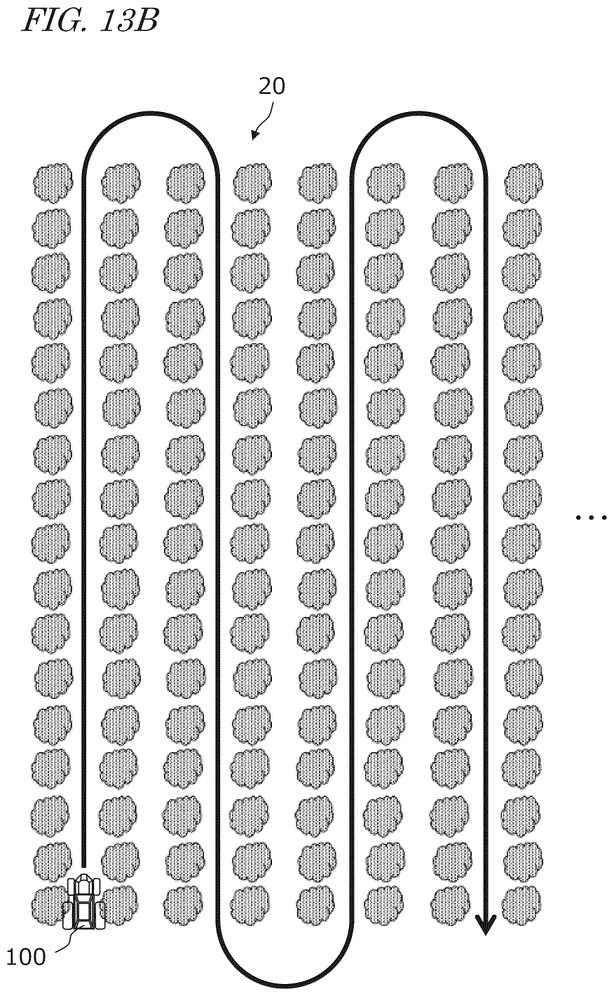

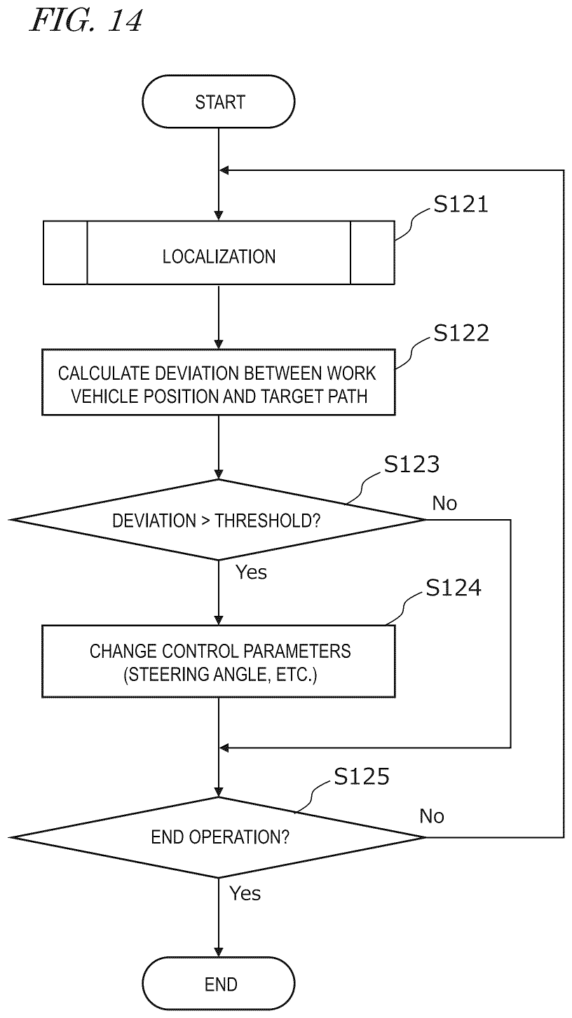

FIG. 14 is a flowchart showing an example operation of steering control to be performed by the controller 180 during self-driving. During travel of the work vehicle 100, the controller 180 performs automatic steering by performing the operation from steps S121 to S125 shown in FIG. 14. The speed of the work vehicle 100 may be maintained at a previously-set speed, for example. The controller 180 is configured or programmed to perform localization on the work vehicle 100 based on data output from the GNSS unit 110 or the LiDAR sensors 140A and 140B while the work vehicle 100 is traveling (step S121). A specific example process of localization is described below. Next, the controller 180 calculates a deviation of the estimated position of the work vehicle 100 from a target path (step S122). The deviation represents the distance between the position of the work vehicle 100 and the target path at that moment. The controller 180 determines whether the calculated deviation in position exceeds the previously-set threshold or not (step S123). If the deviation exceeds the threshold, the controller 180 changes a control parameter of the steering device included in the drive device 240 so as to reduce the deviation, thus changing the steering angle (step S124). If the deviation does not exceed the threshold at step S123, the operation of step S124 is omitted. At the following step S125, the controller 180 determines whether a command to end the operation has been received or not. The command to end the operation may be given when the user has instructed that self-driving be suspended through remote manipulations, or when the work vehicle 100 has arrived at the destination, for example. If the command to end the operation has not been given, the control returns to step S121 and the controller 180 performs substantially the same operation based on a newly measured position of the work vehicle 100. The controller 180 repeats the operation from steps S121 to S125 until a command to end the operation is given. The aforementioned operation is executed by the ECUs 182 and 184 in the controller 180.

In the example shown in FIG. 14, the controller 180 controls the drive device 240 based only on the deviation between the position of the work vehicle 100 and the target path. Alternatively, a deviation in terms of directions may further be considered in the control. For example, when a directional deviation exceeds a previously-set threshold, where the directional deviation is an angle difference between the orientation of the work vehicle 100 estimated by the above localization process, and the direction of the target path, the controller 180 may change the control parameter of the steering device of the drive device 240 (e.g., steering angle) in accordance with the deviation.

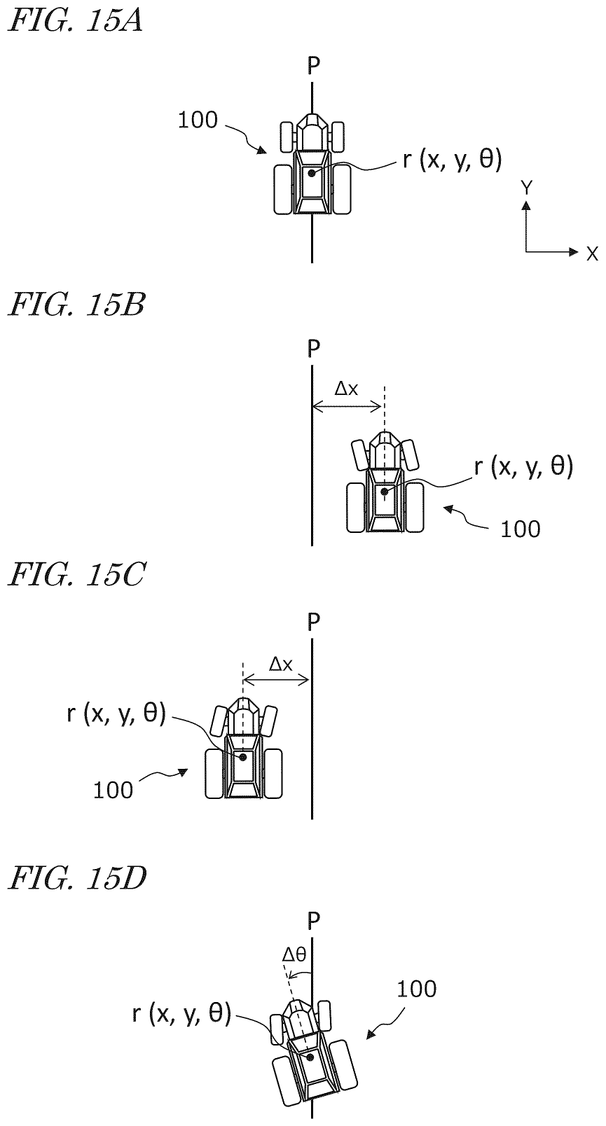

Hereinafter, with reference to FIGS. 15A to 15D, an example of steering control by the controller 180 will be described more specifically.

FIG. 15A is a diagram showing an example of the work vehicle 100 traveling along a target path P. FIG. 15B is a diagram showing an example of the work vehicle 100 at a position which is shifted rightward from the target path P. FIG. 15C is a diagram showing an example of the work vehicle 100 at a position which is shifted leftward from the target path P. FIG. 15D is a diagram showing an example of the work vehicle 100 oriented in an inclined direction with respect to the target path P. In these figures, the pose, i.e., the position and orientation, of the work vehicle 100 as measured by the GNSS unit 110 is expressed as r(x,y,θ). Herein, (x,y) are coordinates representing the position of a reference point on the work vehicle 100 in an XY coordinate system, which is a two-dimensional coordinate system fixed to the globe. In the examples shown in FIGS. 15A to 15D, the reference point on the work vehicle 100 is at a position, on the cabin, where a GNSS antenna is disposed, but the reference point may be at any arbitrary position. θ is an angle representing the measured orientation of the work vehicle 100. Although the target path P is shown parallel to the Y axis in the examples illustrated in these figures, the target path P may not necessarily be parallel to the Y axis, in general.

As shown in FIG. 15A, in the case where the position and orientation of the work vehicle 100 are not deviated from the target path P, the controller 180 maintains the steering angle and speed of the work vehicle 100 without changing them.

As shown in FIG. 15B, when the position of the work vehicle 100 is shifted rightward from the target path P, the controller 180 changes the steering angle so that the traveling direction of the work vehicle 100 will be inclined leftward, thus bringing the work vehicle 100 closer to the path P. At this point, not only the steering angle but also the speed may be changed. The magnitude of the steering angle may be adjusted in accordance with the magnitude of a positional deviation Ax, for example.

As shown in FIG. 15C, when the position of the work vehicle 100 is shifted leftward from the target path P, the controller 180 changes the steering angle so that the traveling direction of the work vehicle 100 will be inclined rightward, thus bringing the work vehicle 100 closer to the path P. In this case, too, not only the steering angle but also the speed may be changed. The amount of change of the steering angle may be adjusted in accordance with the magnitude of the positional deviation Ax, for example.

As shown in FIG. 15D, in the case where the position of the work vehicle 100 is not considerably deviated from the target path P but its orientation is nonetheless different from the direction of the target path P, the controller 180 changes the steering angle so that the directional deviation 40 will become smaller. In this case, too, not only the steering angle but also the speed may be changed. The magnitude of the steering angle may be adjusted in accordance with the magnitudes of the positional deviation Ax and the directional deviation Δθ, for example. For instance, the amount of change of the steering angle (which is in accordance with the directional deviation Δθ) may be increased as the absolute value of the positional deviation Δx decreases. When the positional deviation Δx has a large absolute value, the steering angle will be changed greatly in order for the work vehicle 100 to return to the path P, so that the directional deviation Δθ will inevitably have a large absolute value. Conversely, when the positional deviation Δx has a small absolute value, the directional deviation Δθ needs to become closer to zero. Therefore, it may be advantageous to introduce a relatively large weight (i.e., control gain) for the directional deviation Δθ in determining the steering angle.

For the steering control and speed control of the work vehicle 100, control techniques such as PID control or MPC (Model Predictive Control) may be applied. Applying these control techniques will make for smoothness of the control of bringing the work vehicle 100 closer to the target path P.

Note that, when an obstacle is detected by one or more obstacle sensors 130 during travel, the controller 180 halts the work vehicle 100. At this point, the controller 180 may cause the buzzer 220 to present an alarm sound or may transmit an alert signal to the terminal device 400. In the case where the obstacle is avoidable, the controller 180 may control the drive device 240 such that the obstacle is avoided.

Next, a specific example of the localization process of step S121 in FIG. 14 will be described.

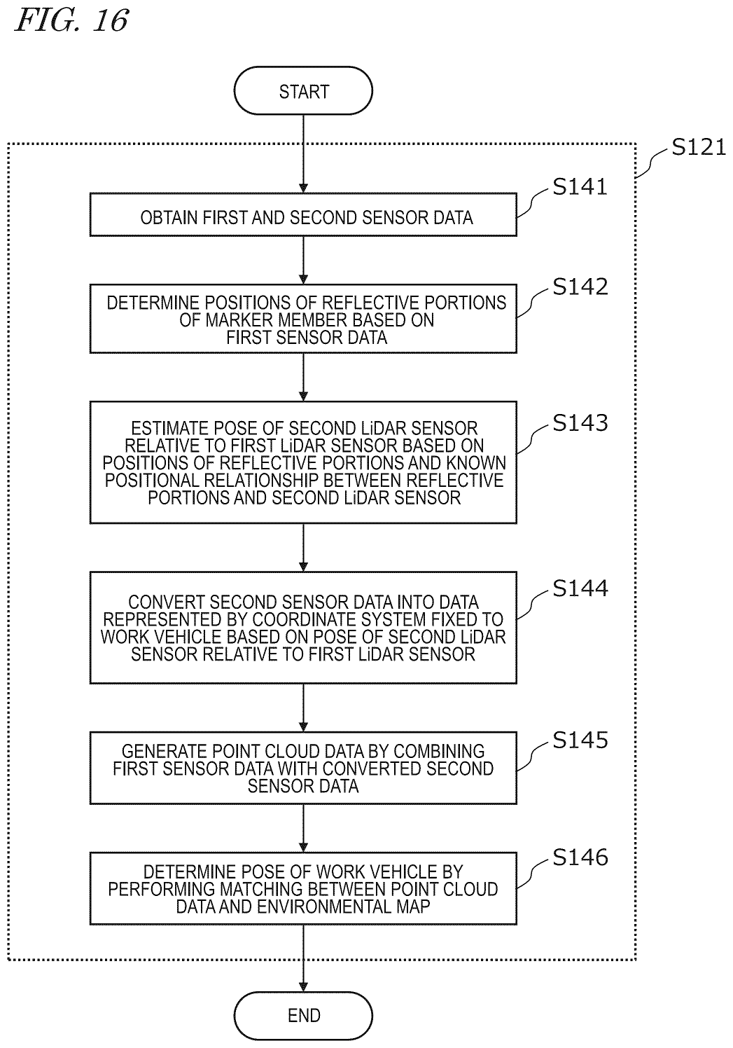

FIG. 16 is a flowchart illustrating a specific example of the process of step S121 in FIG. 14. Here, an example of the localization process based on the first sensor data output from the first LiDAR sensor 140A and the second sensor data output from the second LiDAR sensor 140B will be described. In the example of FIG. 16, step S121 includes the processes of steps S141 to S146.

The ECU 184 (processor) of the controller 180 initially obtains the first sensor data and the second sensor data (step S141). Next, the ECU 184 determines the positions of a plurality of reflective portions of the marker 148 based on the first sensor data (step S142). The plurality of reflective portions have a light reflectance higher than that of the other portions, including, for example, the reflective portions 148a, and 148c 148b, illustrated in FIG. 2 or 4. The ECU 184 estimates the pose of the second LiDAR sensor 140B relative to the first LiDAR sensor 140A based on the positions of the plurality of reflective portions of the marker 148, and a known positional relationship between the plurality of reflective portions and the second LiDAR sensor 140B (step S143). Next, the ECU 184 converts the second sensor data into data in a coordinate system fixed to the work vehicle 100 based on the pose of the second LiDAR sensor 140B relative to the first LiDAR sensor 140A (step S144). Here, the coordinate system fixed to the work vehicle 100 may, for example, be the same as that set for the first LiDAR sensor 140A. The ECU 184 combines the first sensor data and the converted second sensor data to generate point cloud data (step S145). At this time, the ECU 184 may exclude, from the first sensor data, data of points in regions corresponding to the implement 300, the second LiDAR sensor 140B, and the marker 148, before combining the first sensor data and the second sensor data. By performing such a process, data of points not required for localization can be prevented from being included in the point cloud data. It should be noted that the ECU 184 may generate point cloud data only based on the second sensor data that has been subjected to coordinate conversion. Next, the ECU 184 performs matching between the generated point cloud data and an environmental map stored in the storage 170, to determine the pose of the work vehicle 100 (step S146).

By the above operation, the ECU 184 can perform localization on the work vehicle 100. In this example embodiment, the second LiDAR sensor 140B and the marker 148 are mounted on the implement 300, separately from the first LiDAR sensor 140A provided on the work vehicle 100. The pose of the second LiDAR sensor 140B can be estimated based on the first sensor data obtained by the first LiDAR 140A sensing the marker 148. As a result, the second sensor data can be converted into data in a coordinate system fixed to the work vehicle 100, and the data can be used in localization. By such an operation, localization can be performed even when a large-size implement 300 is attached to the work vehicle 100. It should be noted that the above process is not limited

to localization, and may be applied to the case in which obstacle detection is performed using the LiDAR sensors 140A and 140B. Although in this example embodiment the LiDAR sensors 140A and 140B are used, sensors that measure distances using other techniques may be used. For example, techniques similar to the example in which the camera 120 of FIG. 5 is used or the plurality of GNN receivers 110A and 110B of FIG. 7 are used may be applied. Instead of LiDAR sensors, other range sensors such as a stereo camera and ToF camera may be used.

In the foregoing example embodiments, an example in which a sensing system is applied to the agricultural work vehicle 100 such as a tractor has been described. The sensing system is not limited to the agricultural work vehicle 100, and may be used in work vehicles for other applications such as civil engineering work, construction work, or snow removal work.

Example embodiments of the present disclosure are applicable to work vehicles that travel while performing work using an implement. For example, example embodiments of the present disclosure are applicable to work vehicles such as tractors that automatically travel while performing agricultural work with an implement attached to a front or rear portion thereof.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A sensing system comprising:
a first range sensor mounted on a work vehicle;
a second range sensor mounted on an implement connected to the work vehicle;
a marker located in a sensing range of the first range sensor; and
a processor configured or programmed to:
estimate a pose of the second range sensor relative to the first range sensor based on first sensor data generated by the first range sensor sensing a region including the marker; and
output data indicating the estimated pose.

2. The sensing system according to claim 1, wherein the second range sensor includes a mounting structure to mount the second range sensor on the implement, and is external to the implement.

3. The sensing system according to claim 1, wherein the marker is attached to the second range sensor.

4. The sensing system according to claim 1, wherein the processor is configured or programmed to estimate the pose of the second range sensor relative to the first range sensor based on the first sensor data, and information indicating a relationship in position and orientation between the second range sensor and the marker.

5. The sensing system according to claim 1, wherein the processor is configured or programmed to convert second sensor data output from the second range sensor into data represented by a coordinate system fixed to the work vehicle based on the estimated pose, and output the data.

6. The sensing system according to claim 1, wherein
the first range sensor includes a first LiDAR sensor to output the first sensor data;
the second range sensor includes a second LiDAR sensor to output second sensor data;
the marker includes one or more reflective portions having a higher reflectance with respect to light emitted from the first LiDAR sensor than that of the other portion of the marker; and
the processor is configured or programmed to estimate the pose of the second range sensor relative to the first range sensor based on a position and/or shape of the one or more reflective portions.

7. The sensing system according to claim 6, wherein the processor is configured or programmed to convert the second sensor data into data represented by a coordinate system fixed to the work vehicle based on the estimated pose, and generate and output point cloud data based on the first sensor data and the converted second sensor data.

8. The sensing system according to claim 7, wherein the processor is configured or programmed to combine data obtained by excluding, from the first sensor data, data of a region corresponding to the implement and the second range sensor, with the converted second sensor data, to generate the point cloud data.

9. The sensing system according to claim 1, wherein
the first range sensor includes an image sensor to output image data as the first sensor data; and
the processor is configured or programmed to estimate the pose of the second range sensor relative to the first range sensor based on a luminance distribution or color distribution of a region corresponding to the marker in an image indicated by the first sensor data.

10. The sensing system according to claim 1, further comprising:
a storage to store an environmental map; wherein
the processor is configured or programmed to:
convert second sensor data output from the second range sensor into data represented by a coordinate system fixed to the work vehicle, based on the estimated pose;
generate point cloud data indicating a distribution of objects on the ground around the work vehicle based on the converted second sensor data; and
estimate a position of the work vehicle by performing matching between the point cloud data and the environmental map.

11. The sensing system according to claim 1, wherein
the implement is connected to a front portion of the work vehicle; and
the first range sensor is configured to sense at least an area in front of the work vehicle.

12. An agricultural machine comprising the sensing system according to claim 1.

13. A sensing device that is used as the second range sensor in the sensing system according to claim 1; the sensing device comprising:
a mounting structure to mount the sensing device on the implement; wherein
the sensing device is external to the implement.
